(19) United States
(12) Patent Application Publication
(10) Pub. No.: US 2005/0063286 A1
(43) Pub. Date: Mar. 24, 2005

(54) Control module for an automatic gain control device of an optical disc playback apparatus

(75) Inventors: Chih-Chin Hsu, Lu-Chou City (TW); Hsueh-Wu Kao, Hsin-Chu Hsien (TW)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Mediatek Inc

(21) Appl. No.: 10/936,337

(22) Filed: Sep. 8, 2004

(30) Foreign Application Priority Data
Sep. 18, 2003 (TW) 092125801

(51) Int. Cl. G11B 7/00

(52) U.S. Cl. 369/124.1; 369/53.37; 369/44.29

(57) ABSTRACT

A control module for an automatic gain control device of an optical disc playback apparatus includes a constant-gain setting member and a switch member. The playback apparatus includes an optical pickup head for reading an optical disc. The constant-gain setting member provides a constant gain signal. The switch member connects the constant-gain setting member to the automatic gain control device so as to set the automatic gain control device at a predetermined gain when the optical pickup head reads a non-recorded area of the optical disc or performs a track jump operation.

### CROSS-REFERENCE TO RELATED APPLICATION

This application claims priority of Taiwanese application no. 092125801, filed on Sep. 18, 2003.

### BACKGROUND OF THE INVENTION

1. Field of the Invention

The invention relates to a control module, more particularly to a control module for an automatic gain control device of an optical disc playback apparatus.

2. Description of the Related Art

Referring to FIG. 1, a conventional automatic gain control device 23 is coupled between an optical pickup head 21 and an equalizer 22 of an optical disc playback apparatus. Additionally, a pre-amplifier 24 is connected electrically between the optical pickup head 21 and the conventional automatic gain control device 23. The conventional automatic gain control device 23 includes a variable-gain module 231 and a feedback control module 232. The optical pickup head 21 provides a RF signal to the conventional automatic gain control device 23 through the pre-amplifier 24. The pre-amplifier 24 amplifies the RF signal to a level required by the conventional automatic gain control device 23. The variable-gain module 231 provides an output signal (O) to the feedback control module 232 and the equalizer 22. The feedback control module 232 generates an adjusting signal (A) for adjusting gain of the variable-gain module 231 in accordance with the output signal (O). The construction as such permits an amplitude of the output signal (O) to be maintained at a predetermined level.

Although the conventional automatic gain control device 23 achieves its intended purpose, when the optical pickup head 21 reads a non-recorded area of the optical disc or performs a track jump operation, the gain of the variable-gainmodule 231 is undesirably increased. Accordingly, a relatively long response time is required for adjusting the output of the variable-gain module 231 back to normal levels when the optical pickup head 21 reads a recorded track.

In U.S. Pat. No. 5,128,911, there is disclosed a conventional optical disc reproducing apparatus that includes an envelope detector for detecting the output signal of an automatic gain control device, and a comparator that compares the output of the envelope detector with a reference signal. The output of the comparator and a jump signal are then applied to an OR gate, and the OR gate generates a gain hold signal that is applied to the automatic gain control device. By virtue of the gain hold signal, the gain of the automatic gain control device can be set to a predetermined value.

Although the gain of the automatic gain control device in the aforesaid patent can be set to a predetermined value when a non-recorded track of an optical disc is being read or when a track jump operation is being performed, the implementation of the envelope detector and the comparator requires numerous components. This results in higher costs.

### SUMMARY OF THE INVENTION

Therefore, the object of the present invention is to provide a relatively low cost control module that is capable of setting an automatic gain control device to a predetermined gain when an optical pickup head of an optical disc playback apparatus reads a non recorded area of an optical disc or performs a track jump operation.

According to the present invention, a control module for an automatic gain control device of an optical disc playback apparatus includes a constant-gain setting member and a switch member. The optical disc playback apparatus includes an optical pickup head, and generates a status signal corresponding to one of a first playback condition, where the optical pickup head reads a non-recorded area of an optical disc, and a second playback condition, where the optical pickup head performs a track jump operation when reading the optical disc. The automatic gain control device includes a variable-gain module that provides an output signal, and a feedback control module that provides an adjusting signal to the variable-gain module in accordance with the output signal. The constant-gain setting member provides a constant gain signal. The switch member is connected electrically to the constant-gain setting member, is adapted to be connected electrically to the variable-gain module and the feedback control module, and is adapted to receive the status signal. The switch member is operable so as to connect the variable-gain module to the feedback control module, and to simultaneously disconnect the variable-gain module from the constant-gain setting member when the status signal is in a first state. Accordingly, when the variable-gain module receives the adjusting signal, the gain of the variable-gain module is adjusted in accordance with the output signal. The switch member is further operable so as to disconnect the variable-gain module from the feedback control module, and to simultaneously connect the variable-gain module to the constant-gain setting member when the status signal is in a second state. Accordingly, when the variable-gain module receives the constant gain signal, the gain of the variable-gain module is set to a predetermined gain.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of a conventional automatic gain control device incorporated in an optical disc playback apparatus;

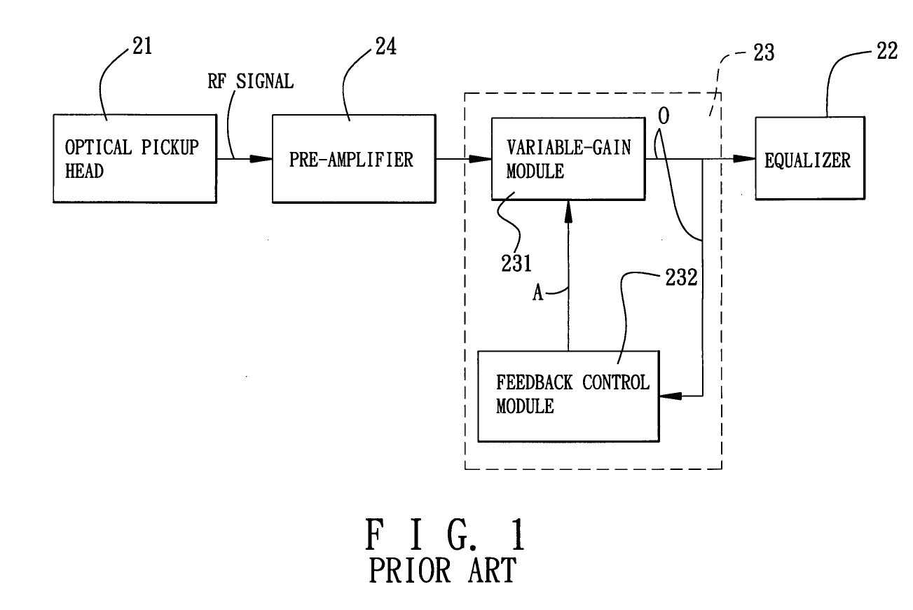

FIG. 2 is a schematic circuit block diagram of the preferred embodiment of a control module incorporated in an automatic gain control device according to the present invention;

FIGS. 3(A) to 3(D) are time charts to illustrate the relation between a radio frequency (RF) signal and a first status signal (RECD1); and

FIGS. 4(A) to 4(D) are time charts to illustrate the relation between the RF signal and a second status signal (TRON).

### DETAILED DESCRIPTION OF THE PREFERRED EMBODIMENT

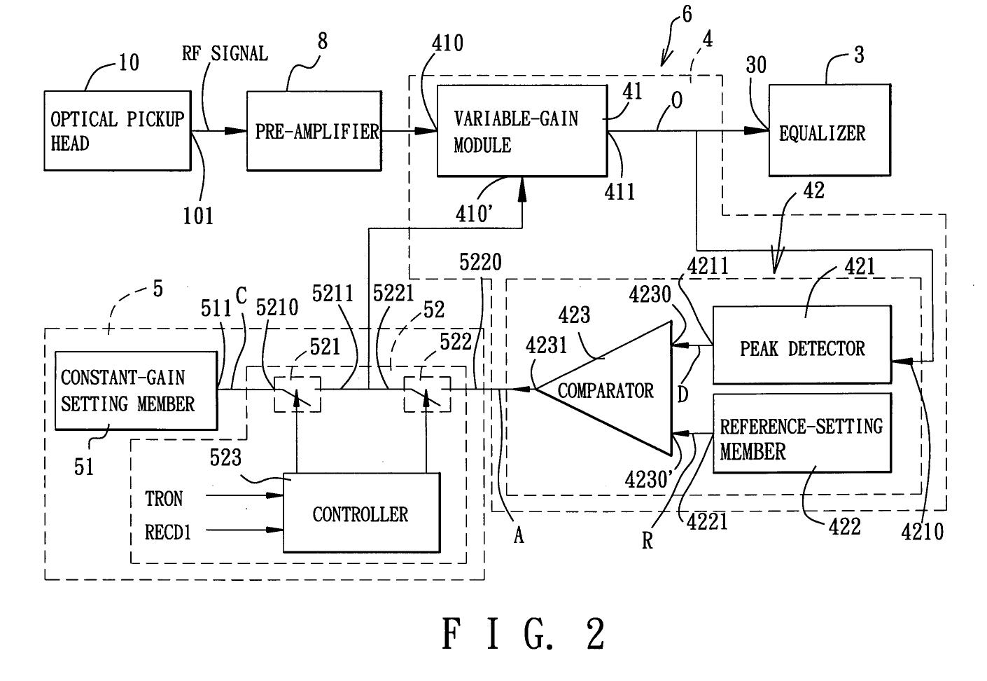

Referring to FIGS. 2 to 4, the preferred embodiment of a control module 5 for an automatic gain control device 4 in an optical disc playback apparatus 6 according to this invention is shown to include a constant-gain setting member 51 and a switch member 52.

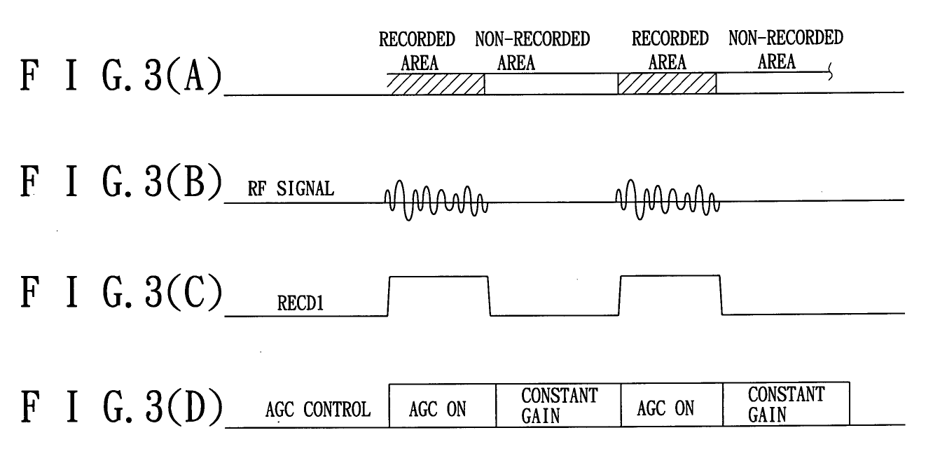

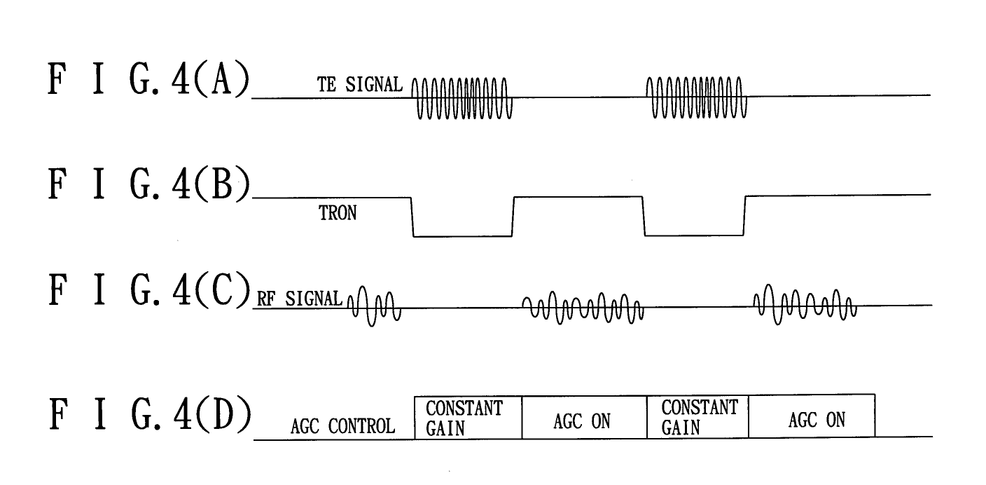

The optical disc playback apparatus 6 includes an optical pickup head 10 for reading an optical disc (not shown). The optical disc playback apparatus 6 further includes a non-recorded area detecting member (not shown) that generates first and second status signals (RECD1, TRON), each of which varies between first and second states. It is noted that the first state is a high logic state and the second state is a low logic state. In a normal playback condition, where the optical pickup head 10 reads a recorded area of the optical disc, the optical pickup head 10 provides a radio frequency (RF) signal at an output terminal 101 thereof. It is noted that when the optical pickup head 10 reads a non-recorded area of the optical disc, the optical pickup head 10 does not provide the RF signal. As best shown in FIG. 3, the first status signal (RECD1) goes from the second state to the first state when the RF signal is provided by the optical pickup head 10. When the optical pickup head 10 performs a jump operation, a tracking error (TE) signal is generated. As best shown in FIG. 4, the second status signal (TRON) goes from the first state to the second state when the TE signal is generated.

In addition, a pre-amplifier 8 is coupled between the optical pickup head 10 and the automatic gain control device 4. The pre-amplifier 8 has an input terminal connected electrically to the output terminal 101 of the optical pickup head 10, and an output terminal. The pre-amplifier 8 amplifies the RF signal to a level required by the automatic gain control device 4.

The automatic gain control device 4 includes a variable-gain module 41 and a feedback control module 42. The variable-gain module 41 has a first input terminal 410 connected electrically to the output terminal of the pre-amplifier 8, a second input terminal 410′, and an output terminal 411 connected electrically to an input terminal 30 of an equalizer 3. The variable-gain module 41 provides an output signal (O) at the output terminal 411 thereof. The feedback control module 42 includes a peak detector 421, a reference-setting member 422, and a comparator 423. The peak detector 421 has an input terminal 4210 connected electrically to the output terminal 411 of the variable-gain module 41, and an output terminal 4211. The peak detector 421 provides a detected signal (D) at the output terminal 4211 thereof. The reference-setting member 422 has an output terminal 4221, and provides a reference signal (R) at the output terminal 4221 thereof. The comparator 423 has first and second input terminals 4230, 4230′, each of which is connected electrically to the output terminal 4211, 4221 of a respective one of the peak detector 421 and the reference-setting member 422, and an output terminal 4231. The comparator 423 of the feedback control module 42 provides an adjusting signal (A) for adjusting gain of the variable-gain module 41 in accordance with the output signal (O), in a manner that will be described hereinafter.

The constant-gain setting member 51 has an output terminal 511, and provides a constant gain signal (C) at the output terminal 511 thereof.

The switch member 52 is connected electrically to the constant-gain setting member 51, is adapted to be connected electrically to the variable-gain module 41 and the feedback control module 42, and is adapted to receive the first and second status signals (RECD1, TRON). In particular, the switch member 52 includes first and second switches 521, 522, and a controller 523. The first switch 521 has a first terminal 5210 connected electrically to the output terminal 511 of the constant-gain setting member 51, and a second terminal 5211 adapted to be connected electrically to the second input terminal 410′ of the variable-gain module 41. The second switch 522 has a first terminal 5220 adapted to be connected electrically to the output terminal 4231 of the comparator 423 of the feedback control module 42, and a second terminal 5221 adapted to be connected electrically to the second input terminal 410′ of the variable-gain module 41. The controller 523 is coupled operably to the first and second switches 521, 522, and is responsive to the first and second status signals (RECD1, TRON).

The switch member 52 is operable so as to connect the variable-gain module 41 to the feedback control module 42, and to simultaneously disconnect the variable-gain module 41 from the constant-gain setting member 51 when both the first and second status signals (RECD1, TRON) are in the first state. In particular, during the normal playback condition, the controller 523 deactivates the first switch 521 to break connection between the output terminal 511 of the constant-gain setting member 51 and the second input terminal 410′ of the variable-gain module 41, and activates the second switch 522 to make connection between the output terminal 4231 of the comparator 423 of the feedback control module 42 and the second input terminal 410′ of the variable-gain module 41. The optical pickup head 10 provides the RF signal to the variable-gain module 41 through the pre-amplifier 8. The gain of the variable-gain module 41 is controlled by the adjusting signal (A). The RF signal is amplified by the variable-gain module 41 to produce the output signal (O). The peak detector 421 detects the output signal (O) and generates the detected signal (D). The detected signal (D) is compared to the reference signal (R) by the comparator 423. The result of the comparison is used to generate the adjusting signal (A). Accordingly, the gain of the variable-gain module 41 is adjusted in accordance with the output signal (O). The construction as such permits an amplitude (not shown) of the output signal (O) to be maintained at a predetermined level.

The switch member 52 is further operable so as to disconnect the variable-gain module 41 from the feedback control module 42, and to simultaneously connect the variable-gain module 41 to the constant-gain setting member 51 when either one of the first and second status signals (RECD1, TRON) is in the second state. In particular, during the first or second playback condition, the controller 523 activates the first switch 521 to make connection between the output terminal 511 of the constant-gain setting member 51 and the second input terminal 410′ of the variable-gain module 41, and deactivates the second switch 522 to break connection between the output terminal 4231 of the comparator 423 of the feedback control module 42 and the second input terminal 410′ of the variable-gain module 41. Accordingly, the variable-gain module 41 receives the constant gain signal (C) for setting the gain of the variable-gain module 41 to a predetermined gain. The construction as such prevents an undesirable increase in the gain of the variable-gain module 41 when the optical pickup head 10 reads a non-recorded area of an optical disc or performs a track jump operation.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A control module for an automatic gain control device of an optical disc playback apparatus, the optical disc playback apparatus including an optical pickup head and generating a status signal corresponding to one of a first playback condition, where said optical pickup head reads a non-recorded area of an optical disc, and a second playback condition, where said optical pickup head performs a track jump operation when reading the optical disc,
the automatic gain control device including a variable-gain module that provides an output signal, and a feedback control module that provides an adjusting signal to the variable-gain module in accordance with the output signal,
said control module comprising:
a constant-gain setting member for providing a constant gain signal; and
a switch member connected electrically to said constant-gain setting member, adapted to be connected electrically to the variable-gain module and the feedback control module, and adapted to receive the status signal,
said switch member being operable so as to connect the variable-gain module to the feedback control module, and to simultaneously disconnect the variable-gain module from said constant-gain setting member when the status signal is in a first state, whereby the variable-gain module receives the adjusting signal for adjusting gain of the variable-gain module in accordance with the output signal,
said switch member being further operable so as to disconnect the variable-gain module from the feedback control module, and to simultaneously connect the variable-gain module to said constant-gain setting member when the status signal is in a second state, whereby the variable-gain module receives said constant gain signal for setting the gain of the variable-gain module to a predetermined gain.

2. The control module as claimed in claim 1, wherein said switch member includes:
a first switch that has a first terminal connected electrically to said constant-gain setting member, and a second terminal adapted to be connected electrically to the variable-gain module;
a second switch that has a first terminal adapted to be connected electrically to the feedback control module, and a second terminal adapted to be connected electrically to the variable-gain module; and
a controller coupled operably to said first and second switches and responsive to the status signal,
said controller deactivating said first switch to break connection between said constant-gain setting member and the variable-gain module, and activating said second switch to make connection between the feedback control module and the variable-gain module when the status signal is in a first state,
said controller activating said first switch to make connection between said constant-gain setting member and the variable-gain module, and deactivating said second switch to break connection between the feedback control module and the variable-gain module when the status signal is in a second state.

3. An automatic gain control device for an optical disc playback apparatus, the optical disc playback apparatus including an optical pickup head and generating a status signal corresponding to one of a first playback condition, where said optical pickup head reads a non-recorded area of an optical disc, and a second playback condition, where said optical pickup head performs a track jump operation when reading the optical disc, said automatic gain control device comprising:
a variable-gain module for providing an output signal;
a feedback control module for providing an adjusting signal to said variable-gain module in accordance with said output signal; and
a control module including
a constant-gain setting member for providing a constant gain signal, and
a switch member connected electrically to said contant-gain setting member, said variable-gain module and said feedback control module, and adapted to receive the status signal,
said switch member being operable so as to connect said variable-gain module to said feedback control module, and to simultaneously disconnect said variable-gain module from said constant-gain setting member when the status signal is in the first state, whereby said variable-gain module receives said adjusting signal for adjusting gain of said variable-gain module in accordance with said output signal,
said switch member being further operable so as to disconnect said variable-gain module from said feedback control module, and to simultaneously connect said variable-gain module to said constant-gain setting member when the status signal is in the second state, whereby said variable-gain module receives said constant gain signal for setting the gain of said variable-gain module to a predetermined gain.

4. The automatic gain controller device as claimed in claim 3, wherein said switch member includes:
a first switch that has a first terminal connected electrically to said constant-gain setting member, and a second terminal adapted to be connected electrically to the variable-gain module;
a second switch that has a first terminal adapted to be connected electrically to the feedback control module, and a second terminal adapted to be connected electrically to the variable-gain module; and
a controller coupled operably to said first and second switches and responsive to the status signal,
said controller deactivating said first switch to break connection between said constant-gain setting member and the variable-gain module, and activating said second switch to make connection between the feedback control module and the variable-gain module when the status signal is in the first state,
said controller activating said first switch to make connection between said constant-gain setting member and the variable-gain module, and deactivating said second switch to break connection between the feedback control module and the variable-gain module when the status signal is in the second state.
